(19) United States
(12) Patent Application Publication
(10) Pub. No.: US 2024/0202014 A1
(43) Pub. Date: Jun. 20, 2024

(54) INTERFACE SCHEDULING METHOD AND DEVICE, AND COMPUTING DEVICE

(71) Applicant: Faurecia Clarion Electronics (Xiamen) Co., Ltd., Xiamen (CN)

(72) Inventors: Yingyuan LIN, Xiamen (CN); Min JIANG, Xiamen (CN); Yuanbiao YANG, Xiamen (CN)

(21) Appl. No.: 18/527,883

(22) Filed: Dec. 4, 2023

(30) Foreign Application Priority Data
Dec. 15, 2022 (CN) 202211618693.1

(51) Int. Cl. G06F 9/451; G06F 9/48

(52) U.S. Cl. CPC G06F 9/451; G06F 9/4881

(57) ABSTRACT

An interface scheduling method is performed by a computing device and includes: obtaining a first request message of an application and an identifier of a second interface, the first request message being used to request a display of a first interface of the application, the first request message including an identifier of the first interface, and the second interface being a currently displayed interface; determining a scheduling result according to a preset scheduling strategy, the identifier of the first interface and the identifier of the second interface, the preset scheduling strategy including priorities of a plurality of identifiers, and the plurality of identifiers including the identifier of the first interface and the identifier of the second interface; and performing an interface scheduling on the first interface and the second interface according to the scheduling result.

### CROSS-REFERENCE TO RELATED APPLICATION

This application claims priority to Chinese Patent Application No. 202211618693.1, filed on Dec. 15, 2022, which is incorporated herein by reference in its entirety.

### TECHNICAL FIELD

The present disclosure relates to the field of computer technologies, and in particular, to an interface scheduling method, an interface scheduling device, and a computing device.

### BACKGROUND

At present, the in-vehicle infotainment (IVI) system is usually the Android operating system. When scheduling an interface of an application in the Android operating system, the interface scheduling is usually performed based on an interface stacking manner.

The Android operating system is usually used in mobile phone scenarios. Since the interface scheduling requirements in mobile phone scenarios and IVI scenarios are different, the interface scheduling based on the interface stacking manner has low flexibility when facing the IVI scenarios.

### SUMMARY

In a first aspect, an interface scheduling method is provided. The interface scheduling method is performed by a computing device. The interface scheduling method includes: obtaining a first request message of an application and an identifier of a second interface, the first request message being used to request a display of a first interface of the application, the first request message including an identifier of the first interface, and the second interface being a currently displayed interface; determining a scheduling result according to a preset scheduling strategy, the identifier of the first interface and the identifier of the second interface, the preset scheduling strategy including priorities of a plurality of identifiers, and the plurality of identifiers including the identifier of the first interface and the identifier of the second interface; and performing interface scheduling on the first interface and the second interface according to the scheduling result.

In some implementation manners of the first aspect, determining the scheduling result according to the preset scheduling strategy, the identifier of the first interface and the identifier of the second interface includes: determining a first priority of the identifier of the first interface in the preset scheduling strategy; determining a second priority of the identifier of the second interface in the preset scheduling strategy; and in a case where the first priority is lower than the second priority, determining that the scheduling result is to not display the first interface and to display the second interface.

In some implementation manners of the first aspect, determining the scheduling result according to the preset scheduling strategy, the identifier of the first interface and the identifier of the second interface includes: determining a first priority of the identifier of the first interface in the preset scheduling strategy; determining a second priority of the identifier of the second interface in the preset scheduling strategy; and in a case where the first priority is higher than the second priority, determining that the scheduling result is to display the first interface and to not display the second interface.

In some implementation manners of the first aspect, the interface scheduling method further includes: obtaining a second request message of the application, the second request message being used to request that the first interface not be displayed, and the second request message includes the identifier of the first interface; and removing the first priority of the identifier of the first interface in the preset scheduling strategy to obtain a first scheduling strategy such that the first interface is not displayed and the second interface is displayed.

In a second aspect, an interface scheduling device is provided. The interface scheduling device includes an obtaining module and a processing module. The obtaining module is used to obtain a first request message of an application and an identifier of a second interface; the first request message is used to request a display of a first interface of the application, the first request message includes an identifier of the first interface, and the second interface is a currently displayed interface. The processing module is used to determine a scheduling result according to a preset scheduling strategy, the identifier of the first interface and the identifier of the second interface; the preset scheduling strategy includes priorities of a plurality of identifiers, and the plurality of identifiers include the identifier of the first interface and the identifier of the second interface. The processing module is further used to perform an interface scheduling on the first interface and the second interface according to the scheduling result.

In some implementation manners of the second aspect, the processing module is used to determine the scheduling result according to a preset scheduling strategy, the identifier of the first interface and the identifier of the second interface includes the processing module is used to: determine a first priority of the identifier of the first interface in the preset scheduling strategy; determine a second priority of the identifier of the second interface in the preset scheduling strategy; and in a case where the first priority is lower than the second priority, determine that the scheduling result is to not display the first interface and to display the second interface.

In some implementation manners of the second aspect, the processing module is used to determine the scheduling result according to a preset scheduling strategy, the identifier of the first interface and the identifier of the second interface includes the processing module is used to: determine a first priority of the identifier of the first interface in the preset scheduling strategy; determine a second priority of the identifier of the second interface in the preset scheduling strategy; and in a case where the first priority is higher than the second priority, determine that the scheduling result is to display the first interface and to not display the second interface.

In some implementation manners of the second aspect, the processing module is further used to: obtain a second request message of the application, the second request message being used to request that the first interface not be displayed, and the second request message including the identifier of the first interface; and remove the first priority of the identifier of the first interface in the preset scheduling strategy to obtain a first scheduling strategy such that the first interface is not displayed and the second interface is displayed.

In a third aspect, a computer device is provided. The computing device includes a processor and a memory. The processor is connected to the memory. The memory is used to store programs or instructions. The programs or the instructions stored on the memory, when executed by the processor, cause the computing device to perform the interface scheduling method provided by the above-mentioned first aspect and any one of the implementation manners of the first aspect.

In a fourth aspect, a non-transitory computer-readable storage medium is provided. The computer-readable storage medium has stored thereon computer programs or instructions that, when run on a computer, cause the computer to perform the interface scheduling method provided by the above-mentioned first aspect and any one of the implementation manners of the first aspect.

In a fifth aspect, a computer program product is provided. The computer program product includes instructions carried on a non-transitory computer-readable storage medium. The instructions, when run on a computer, cause the computer to perform the interface scheduling method provided by the above-mentioned first aspect and any one of the implementation manners of the first aspect.

### BRIEF DESCRIPTION OF THE DRAWINGS

In order to describe technical solutions in the present disclosure more clearly, the accompanying drawings to be used in some embodiments of the present disclosure will be introduced briefly below. However, the accompanying drawings to be described below are merely accompanying drawings of some embodiments of the present disclosure, and a person of ordinary skill in the art can obtain other drawings according to these drawings. In addition, the accompanying drawings to be described below may be regarded as schematic diagrams and are not limitations on actual sizes of products and actual processes of methods involved in the embodiments of the present disclosure.

FIG. 1 is a schematic diagram showing an architecture of an interface scheduling system, in accordance with some embodiments of the present disclosure;

FIG. 2 is a schematic flowchart of an interface scheduling method, in accordance with some embodiments of the present disclosure;

FIG. 3 is a schematic structural diagram of an interface, in accordance with some embodiments of the present disclosure;

FIG. 4 is a schematic flowchart of another interface scheduling method, in accordance with some embodiments of the present disclosure;

FIG. 5 is a schematic flowchart of yet another interface scheduling method, in accordance with some embodiments of the present disclosure;

FIG. 6 is a schematic flowchart of yet another interface scheduling method, in accordance with some embodiments of the present disclosure;

FIG. 7 is a schematic structural diagram of an interface scheduling device, in accordance with some embodiments of the present disclosure; and

FIG. 8 is a schematic structural diagram of a computing device, in accordance with some embodiments of the present disclosure.

### DETAILED DESCRIPTION

Technical solutions in some embodiments of the present disclosure will be described clearly and completely below with reference to the accompanying drawings. However, the described embodiments are merely some but not all embodiments of the present disclosure. All other embodiments obtained by a person of ordinary skill in the art based on the embodiments of the present disclosure shall be included in the protection scope of the present disclosure.

Unless the context requires otherwise, throughout the specification and the claims, the term “comprise” and other forms thereof such as the third-person singular form “comprises” and the present participle form “comprising” are interpreted as open and inclusive meaning, i.e., “including, but not limited to”. In the description of the specification, the term such as “an embodiment”, “some embodiments”, “exemplary embodiments”, “example”, “specific example” or “some examples” are intended to indicate that specific features, structures, materials or characteristics related to the embodiment(s) or example(s) are included in at least one embodiment or example of the present disclosure. Schematic representation of the above term does not necessarily refer to the same embodiment(s) or example(s). In addition, the specific features, structures, materials or characteristics may be included in any one or more embodiments or examples in any suitable manner. Any embodiment or solution described herein with “for example” in the embodiments of the present disclosure is not necessarily to be construed as preferred or advantageous over other embodiments or solutions.

In the description of some embodiments, the term “connected” and its derivatives may be used. For example, the term “connected” may be used when describing some embodiments to indicate that two or more components are in direct physical contact or electrical contact with each other. However, the term “connected” or “communicatively connected” may also mean that two or more components are not in direct contact with each other but still cooperate or interact with each other. The embodiments disclosed herein are not necessarily limited to the content herein.

As used herein, depending on the context, the term “if” is optionally construed as “when” or “in a case where” or “in response to determining” or “in response to detecting” Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]”, depending on the context.

The use of “used to” or “configured to” herein indicates an open and inclusive expression, which does not exclude devices that are used to or configured to perform additional tasks or steps.

In addition, the phrase “based on” as used herein is meant to be open and inclusive, since a process, step, calculation or other action that is “based on” one or more of the stated conditions or values may, in practice, be based on additional conditions or value exceeding those stated.

The phrase “at least one of A, B, and C” has a same meaning as the phrase “at least one of A, B, or C” and they both include the following combinations of A, B, and C: only A, only B, only C, a combination of A and B, a combination of A and C, a combination of B and C, and a combination of A, B, and C.

The phrase “A and/or B” includes the following three combinations: only A, only B, and a combination of A and B.

In the description of the embodiments of the present disclosure, the term “multiple”, “a plurality of” or “the plurality of” means two or more unless otherwise specified.

Hereinafter, the terms “first” and “second” are only used for descriptive purposes and cannot be construed as indicating or implying the relative importance or implicitly indicating the number of indicated technical features and the execution order. Thus, a feature defined with “first” or “second” may explicitly or implicitly include one or more features. In addition, in order to facilitate a clear description of the technical solutions of the embodiments of the present disclosure, in the embodiments of the present disclosure, the terms such as “first” and “second” are used to distinguish the same or similar features that have substantially the same functions and effects. Furthermore, features defined with “first”, “second”, etc. are not necessarily limited to different features.

It can be understood that in the embodiments of the present disclosure, the sequence numbers of processes or steps do not mean the order of execution. The execution order of the processes or steps should be determined by their functions and internal logic, and should not constitute any limitation on the implementation processes in the embodiments of the present disclosure.

It can be understood that some optional features in the embodiments of the present disclosure can be implemented independently in certain scenarios without relying on other features, or can also be implemented in combination with other features according to the needs in certain scenarios, thus solving corresponding technical problems and achieving corresponding effects. Correspondingly, the devices provided in the embodiments of the present disclosure can also implement these features or functions, which will not be repeated here.

In the embodiments of the present disclosure, unless otherwise specified, the same or similar parts between the embodiments may be referred to each other. In the embodiments of the present disclosure and the implementation manners in the embodiments, if there are no special instructions and logical conflicts, the terms and/or descriptions of the different embodiments and the implementation manners in the embodiments are consistent and can be referred to each other, and the features in the different embodiments and the implementation manners in the embodiments can be combined to form new embodiments or new implementation manners according to the inherent logical relationship between the different embodiments and the implementation manners. The following implementation manners of the present disclosure do not constitute limitations to the protection scope of the present disclosure.

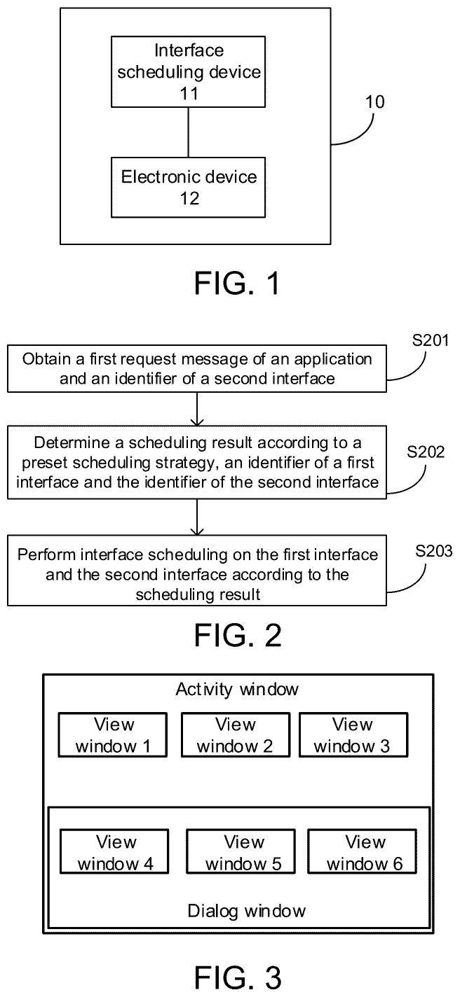

FIG. 1 is a schematic diagram showing an architecture of an interface scheduling system provided in embodiments of the present disclosure. The technical solutions provided by the embodiments of the present disclosure can be applied to the interface scheduling system shown in FIG. 1. As shown in FIG. 1, the interface scheduling system 10 includes an interface scheduling device 11 and an electronic device 12.

The interface scheduling device 11 is directly connected or indirectly connected to the electronic device 12. The interface scheduling device 11 and the electronic device 12 may be connected in a wired manner or in a wireless manner, which is not limited in the embodiments of the present disclosure.

The interface scheduling device 11 is used to receive data from the electronic device 12. In some examples, the interface scheduling device 11 is a computing device, such as a computer, a tablet computer, a notebook computer, or other device with computing functions.

The electronic device 12 is used to transmit data to the interface scheduling device 11.

It should be noted that the interface scheduling device 11 and the electronic device 12 may be independent devices or may be integrated into the same device, which is not limited in the embodiments of the present disclosure.

When the interface scheduling device 11 and the electronic device 12 are integrated into the same device, the communication between the interface scheduling device 11 and the electronic device 12 is the communication between internal modules of the device. In this case, the communication process between the interface scheduling device 11 and the electronic device 12 is the same as the “communication process between the interface scheduling device 11 and the electronic device 12 when they are independent of each other.”

The following embodiments of the present disclosure will be described by taking an example in which the interface scheduling device 11 and the electronic device 12 are arranged independently of each other.

In practical applications, the interface scheduling method provided by the embodiments of the present disclosure can be performed by the interface scheduling device 11, or can be performed by device(s) included in the interface scheduling device 11.

With reference to the accompanying drawings, the interface scheduling method provided in the embodiments of the present disclosure will be described below by taking an example in which the interface scheduling method is performed by the interface scheduling device 11 (e.g., the computing device).

FIG. 2 is a schematic flowchart of an interface scheduling method provided in the embodiments of the present disclosure. As shown in FIG. 2, the interface scheduling method includes the following steps.

In S201, the interface scheduling device obtains a first request message of an application (which is also referred to as a first application herein) and an identifier of a second interface.

The first request message is used to request a display of a first interface of the first application, the first request message includes an identifier of the first interface, and the second interface is a currently displayed interface.

It should be noted that the interface scheduling device can also be called AppFocusService. Of course, the interface scheduling device can also have other names, which is not limited in the embodiments of the present disclosure.

The first application may be a map application, or the first application may be a music application, which is not limited in the embodiments of the present disclosure.

The first request message may be an interface display request message, or the first request message may be a first interface display request message, which is not limited in the embodiments of the present disclosure.

The first interface or the second interface may be a status bar interface, or the first interface or the second interface may be a volume adjustment interface, or the first interface or the second interface may be other interfaces, which is not limited in the embodiments of the present disclosure.

The identifier of the interface may be represented as interface identifier A, or the identifier of the interface may be represented as interface identifier B, or the identifier of the interface may also be represented as interface identifier C, which is not limited in the embodiments of the present disclosure.

FIG. 3 is a schematic structural diagram of an interface provided by the embodiments of the present disclosure. As shown in FIG. 3, the interface may include an activity window; the activity window may include a view window 1, a view window 2, a view window 3, and a dialog window; and the dialog window may include a view window 4, a view window 5, and a view window 6.

The activity window is a container of view windows, and is used to present a full-screen interface. The activity window presents exclusive features on the screen through a full-screen occupancy mode. For example, the activity window can be the desktop of the in-vehicle infotainment (IVI). By clicking an application icon on the desktop of the IVI to enter the application, two activity windows are switched.

The dialog window is also a container of view windows, and is used to present pop-up window(s) or non-full-screen interface(s). The dialog window occupies a part of the screen and is located on the activity window. For example, the dialog window is any pop-up window in the IVI.

The view windows are a collection of interface elements in the interface. For example, when the activity window is the desktop of the mobile phone, the view windows may be icons or buttons of applications in the desktop of the mobile phone.

In a possible implementation manner, with reference to FIG. 1, the interface scheduling device receives a message from the electronic device, the message includes the first request message of the first application and the identifier of the second interface, and the interface scheduling device obtains the first request message of the first application and the identifier of the second interface from the message.

In another possible implementation manner, the interface scheduling device receives a message from the first application through proxy instance(s) of Binder corresponding to the first application, the message includes the first request message of the first application, and the interface scheduling device obtains the first request message of the first application from the message. The interface scheduling device receives a message from the electronic device, the message includes the identifier of the second interface, and the interface scheduling device obtains the identifier of the second interface from the message.

It should be noted that Binder is a drive program based on the Linux kernel. Binder is divided into server side and agent side, and two applications communicate by obtaining each other's proxy instance(s).

In S202, the interface scheduling device determines a scheduling result (which is also referred to as a target scheduling result herein) according to a preset scheduling strategy, the identifier of the first interface, and the identifier of the second interface.

The preset scheduling strategy includes priorities of a plurality of identifiers, and the plurality of identifiers include the identifier of the first interface and the identifier of the second interface.

It should be noted that in a case where the plurality of identifiers are interface identifier A, interface identifier B, and interface identifier C, the priority of interface identifier A, the priority of interface identifier B, and the priority of interface identifier C are respectively priority 1, priority 2, and priority 3, and may be expressed as interface identifier A—priority 1, interface identifier B—priority 2, and interface identifier C—priority 3. The types and expressions of the plurality of identifiers and the types and expressions of priorities of the plurality of identifiers are not limited in the embodiments of the present disclosure.

For example, when the priority of interface identifier A, the priority of interface identifier B, and the priority of interface identifier C are respectively expressed as interface identifier A—priority 1, interface identifier B—priority 2, and interface identifier C—priority 3, the preset scheduling strategy is expressed as [interface identifier A—priority 1, interface identifier B—priority 2, interface identifier C—priority 3].

The target scheduling result may be to display the first interface and to not display the second interface, or the target scheduling result may be to not display the first interface and to display the second interface, which is not limited in the embodiments of the present disclosure.

When the target scheduling result is to display the first interface and to not display the second interface, the target scheduling result may be called mutually exclusive display. The mutually exclusive display means that two interfaces cannot be displayed at the same time, and only one of them can be displayed. For example, when the priorities of the identifiers of two interfaces are different, only the interface with the higher priority of the identifier can be displayed. As another example, when the priorities of the identifiers of two interfaces are the same, only the interface to be displayed later can be displayed.

For example, in a case where the priorities of the identifiers of the two interfaces are the same, when a left-pulled shortcut panel interface that has undergone a pull-left operation is displayed, if a pull-right operation is performed, a right-pulled shortcut panel interface will be displayed, and the left-pulled shortcut panel interface will not be displayed (that is, the left-pulled shortcut panel interface will be hidden); then, if a pull-down operation is performed, a down-pulled message center interface will be displayed, and the right-pulled shortcut panel interface will not be displayed (that is, the right-pulled shortcut panel interface will be hidden).

In a case where the target scheduling result is to not display the first interface and to display the second interface, the target scheduling result may also be called display inhibition. Display inhibition means that when an interface corresponding to a high-priority identifier is displayed, an interface corresponding to a low-priority identifier is not displayed. For example, when a login interface corresponding to a high-priority identifier is displayed, a call interface corresponding to a low-priority identifier is not displayed.

In some cases, the target scheduling result may further include mutual overlap. The mutual overlap means that when priorities of identifiers of two interfaces are the same, the two interfaces can overlap each other in order. For example, when a call interface is being displayed, a shortcut panel interface can be displayed on and cover the call interface. As another example, when the shortcut panel interface is being displayed, the call interface can be displayed on and cover the shortcut panel interface.

In a possible implementation manner, the interface scheduling device determines the priority corresponding to the identifier of the first interface and the priority corresponding to the identifier of the second interface according to the priorities of the plurality of identifiers in the preset scheduling strategy, and determines the target scheduling result according to the priority corresponding to the identifier of the first interface and the priority corresponding to the identifier of the second interface.

It should be noted that, as for the details of this possible implementation manner, reference can be made to the following introductions in the detailed description of this application, which will not be provided here in the embodiments of the present disclosure.

In S203, the interface scheduling device performs interface scheduling on the first interface and the second interface according to the scheduling result (namely, the target scheduling result).

In a possible implementation manner, when the target scheduling result is to display the first interface and to not display the second interface, the interface scheduling device transmits a first instruction message to the first application through a Listener callback interface, so that the first application displays the first interface by calling startActivity of Context, or by calling Show of dialog.Builder, or by calling addWindow of WindowManagerService, or by calling addView of WindowManager, and the interface scheduling device does not display the second interface by calling Finish or onStop of Activity, or by calling remove View of WindowManager, or by calling Dismiss of Dialog.

In another possible implementation manner, when the target scheduling result is to not display the first interface but to display the second interface, the interface scheduling device transmits a first notification message to the first application through a Listener callback interface to notify that the first interface of the first application cannot be displayed.

It should be noted that each application can register in advance with the interface scheduling device to monitor interface scheduling events through registerViewFocusListener.

Based on this solution, the target scheduling result is determined according to the identifier of the first interface of the first application, the identifier of the second interface and the preset scheduling strategy. Compared with a solution of interface scheduling based on an interface stacking manner, in the solutions provided by the embodiments of the present disclosure, the preset scheduling strategy includes the priority of the identifier of the first interface and the priority of the identifier of the second interface, so that the interface scheduling can be performed according to the priorities of the identifiers of the interfaces instead of stacking. Thus, the flexibility of the interface scheduling is improved.

The solutions provided by the embodiments of the present disclosure and the interface scheduling method provided by the embodiments of the present disclosure will be further described below with reference to the accompanying drawings.

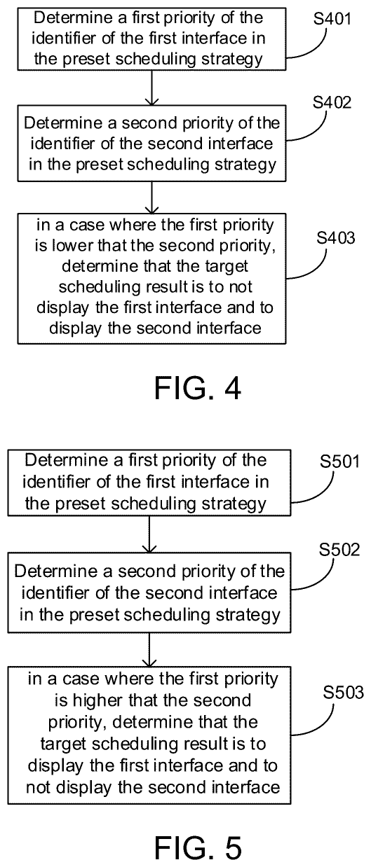

In some embodiments, FIG. 4 is a schematic flowchart of another interface scheduling method provided in the embodiments of the present disclosure. As shown in FIG. 4, S202 provided in the embodiments of the present disclosure includes the following steps S401 to S403.

In S401, the interface scheduling device determines a first priority of the identifier of the first interface in the preset scheduling strategy.

In a possible implementation manner, the interface scheduling device finds the first priority corresponding to the identifier of the first interface in the preset scheduling strategy.

For example, if the preset scheduling strategy is [interface identifier A—priority 1, interface identifier B—priority 2, interface identifier C—priority 3] and the identifier of the first interface is interface identifier B, the interface scheduling device finds out that the first priority corresponding to interface identifier B is priority 2.

In S402, the interface scheduling device determines a second priority of the identifier of the second interface in the preset scheduling strategy.

In a possible implementation manner, the interface scheduling device finds the second priority corresponding to the identifier of the second interface in the preset scheduling strategy.

For example, if the preset scheduling strategy is [interface identifier A—priority 1, interface identifier B—priority 2, interface identifier C—priority 3] and the identifier of the second interface is interface identifier C, the interface scheduling device finds out that the second priority corresponding to interface identifier C is priority 3.

In S403, the interface scheduling device determines that the target scheduling result is to not display the first interface and to display the second interface in a case where the first priority is lower than the second priority.

In a possible implementation manner, considering the first priority in the example in S401 and the second priority in the example in S402 as an example, priority 2 is lower than priority 3, and in a case where the interface scheduling device determines that the first priority is lower than the second priority, the interface scheduling device determines that the target scheduling result is to not display the first interface and to display the second interface.

On this basis, it is possible to realize the solution for determining the target scheduling result based on the preset scheduling strategy, the identifier of the first interface, and the identifier of the second interface.

In some embodiments, FIG. 5 is a schematic flowchart of yet another interface scheduling method provided in the embodiments of the present disclosure. As shown in FIG. 5, S202 provided in the embodiments of the present disclosure includes the following steps S501 to S503.

In S501, the interface scheduling device determines a first priority of the identifier of the first interface in the preset scheduling strategy.

In a possible implementation manner, the interface scheduling device finds the first priority corresponding to the identifier of the first interface in the preset scheduling strategy.

For example, if the preset scheduling strategy is [interface identifier A—priority 1, interface identifier B—priority 2, interface identifier C—priority 3] and the identifier of the first interface is interface identifier B, the interface scheduling device finds out that the first priority corresponding to the interface identifier B is priority 2.

In S502, the interface scheduling device determines a second priority of the identifier of the second interface in the preset scheduling strategy.

In a possible implementation manner, the interface scheduling device finds the second priority corresponding to the identifier of the second interface in the preset scheduling strategy.

For example, if the preset scheduling strategy is [interface identifier A—priority 1, interface identifier B—priority 2, interface identifier C—priority 3] and the identifier of the second interface is interface identifier A, the interface scheduling device finds out that the second priority corresponding to the interface identifier A is priority 1.

In S503, the interface scheduling device determines that the target scheduling result is to display the first interface and to not display the second interface in a case where the first priority is higher than the second priority.

In a possible implementation manner, considering the first priority in the example in S501 and the second priority in the example in S502 as an example, priority 2 is higher than priority 1, and in a case where the interface scheduling device determines that the first priority is higher than the second priority, the interface scheduling device determines that the target scheduling result is to display the first interface and to not display the second interface.

For example, the interface scheduling device determines that the first priority is higher than the second priority, the interface scheduling device processes external logic (such as sending a broadcast to close a lock screen); then, the interface scheduling device updates the Bluetooth phone display status and cancels all Toast displays; next, the interface scheduling device searches for data in the currently displayed window that is incompatible with the window to be displayed, and notifies the data to be hidden, and then, determines that the target scheduling result is to display the first interface and to not display the second interface.

On this basis, it is possible to realize the solution for determining the target scheduling result based on the preset scheduling strategy, the identifier of the first interface, and the identifier of the second interface.

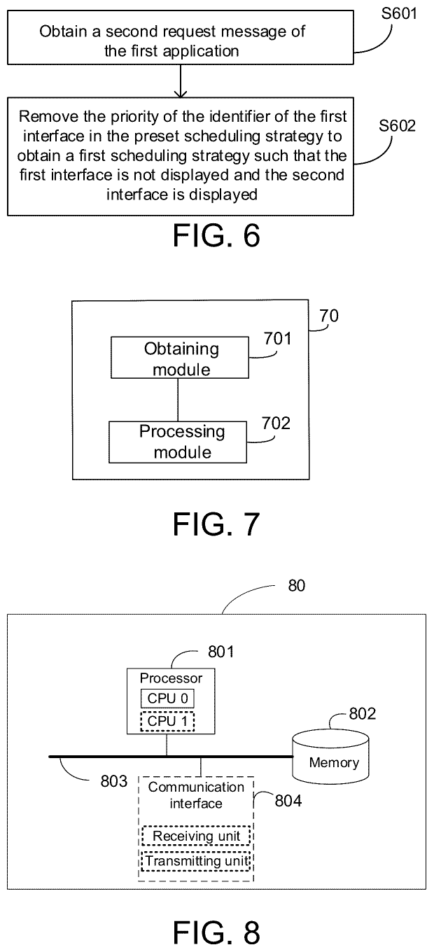

In some embodiments, FIG. 6 is a schematic flowchart of yet another interface scheduling method provided in the embodiments of the present disclosure; as shown in FIG. 6, after the first interface is displayed, the interface scheduling method provided in the embodiments of the present disclosure further includes the following steps S601 and S602.

In S601, the interface scheduling device obtains a second request message of the first application.

The second request message is used to request that the first interface not be displayed, and the second request message includes the identifier of the first interface.

The second request message may be an interface stop display request message, or the second request message may also be a first interface stop display request message, which will not be limited in the embodiments of the present disclosure.

In a possible implementation manner, with reference to FIG. 1, the interface scheduling device receives a message from the electronic device, the message includes the second request message of the first application, and the interface scheduling device obtains the second request message of the first application from the message.

In another possible implementation manner, the interface scheduling device receives a message from the first application through proxy instance(s) of Binder corresponding to the first application, the message includes the second request message of the first application, and the interface scheduling device obtains the second request message of the first application from the message.

In S602, the interface scheduling device removes the priority of the identifier of the first interface in the preset scheduling strategy to obtain a first scheduling strategy, so as to not display the first interface and to display the second interface.

It should be noted that not displaying the first interface and displaying the second interface may also be called echo display. The echo display means that when a high-priority interface is displayed, a low-priority interface is not displayed; and after the high-priority interface is not displayed, the low-priority interface is redisplayed. That is, in a case where the priority of the first interface is lower than the priority of the second interface, when the second interface is displayed, the first interface is not displayed, and when the second interface is not displayed, the first interface is redisplayed. For example, when the call interface is being displayed, if the automatic parking interface or valet parking interface needs to be displayed, the call interface will not be displayed (i.e., the call interface will be hidden), and the automatic parking interface or valet parking interface will be displayed; after that, if the automatic parking interface or valet parking interface is not displayed (that is, exiting the automatic parking interface or valet parking interface), the call interface will be redisplayed.

In a possible implementation manner, considering an example in which the preset scheduling strategy is [interface identifier A-priority 1, interface identifier B—priority 2, interface identifier C—priority 3] and the identifier of the first interface is interface identifier B, the interface scheduling device determines the first scheduling strategy as [interface identifier A—priority 1, interface identifier C—priority 3], and displays the second interface. The second interface may be the interface corresponding to the interface identifier A or the interface corresponding to the interface identifier C.

On this basis, after the first interface is displayed, the first interface can be closed if the first interface does not need to continue to be displayed.

The foregoing mainly introduces the solutions provided by the embodiments of the present disclosure from perspective of the interface scheduling device performing the interface scheduling method. In order to achieve the above functions, the interface scheduling device includes corresponding hardware structures and/or software modules for performing various functions. A person skilled in the art will be easy to realize that by combining units and algorithm steps of the examples described in the embodiments disclosed herein, the embodiments of the present disclosure can be implemented through hardware or a combination of hardware and computer software. Whether a certain function is implemented by the hardware or the computer software-driven hardware depends on specific applications and design constraints of the technical solution. A person skilled in the art may use different methods for each specific application to implement the described functions, but such implementation should not be considered beyond the scope of the present disclosure.

The embodiments of the present disclosure can divide the interface scheduling device into functional modules according to the above method examples. For example, each functional module can be divided corresponding to each function, or two or more functions can be integrated into one processing module. The integrated modules may be implemented in a form of hardware or software functional modules. Optionally, the division of modules in the embodiments of the present disclosure is schematic, and is only a division according to logical functions, and there may be other division manners in actual implementation.

The embodiments of the present disclosure provide an interface scheduling device. In some examples, the interface scheduling device is a computing device.

In some embodiments, FIG. 7 is a schematic structural diagram of the interface scheduling device. As shown in FIG. 7, the interface scheduling device includes an obtaining module 701 and a processing module 702.

In some embodiments, the interface scheduling device 70 further includes a storage module (not shown in FIG. 7) used to store program instructions and data.

The obtaining module 701 is used to obtain a first request message of a first application and an identifier of a second interface. The first request message is used to request display of a first interface of the first application. The first request message includes an identifier of the first interface. The second interface is a currently displayed interface. The processing module 702 is used to determine a target scheduling result according to a preset scheduling strategy, the identifier of the first interface, and the identifier of the second interface. The preset scheduling strategy includes priorities of a plurality of identifiers, and the plurality of identifiers include the identifier of the first interface and the identifier of the second interface. The processing module 702 is further used to perform interface scheduling on the first interface and the second interface according to the target scheduling result.

It should be noted that the “module” here may refer to an application-specific integrated circuits (ASIC), a circuit, a processor that execute one or more software or firmware programs, a memory, an integrated logic circuit, and/or other devices that can perform the above functions. For example, the obtaining module is an ASIC, the processing module is a processor, and the storage module is a memory.

Optionally, the processing module 702 is used to determine the target scheduling result according to the preset scheduling strategy, the identifier of the first interface, and the identifier of the second interface, includes the processing module 702 is used to: determine a first priority of the identifier of the first interface in the preset scheduling strategy; determine a second priority of the identifier of the second interface in the preset scheduling strategy; and in a case where the first priority is lower than the second priority, determine the target scheduling result to not display the first interface and to display the second interface.

Optionally, the processing module 702 is used to determine the target scheduling result according to the preset scheduling strategy, the identifier of the first interface, and the identifier of the second interface, includes the processing module 702 is used to: determine the first priority of the identifier of the first interface in the preset scheduling strategy; determine the second priority of the identifier of the second interface in the preset scheduling strategy; and in a case where the first priority is higher than the second priority, determine the target scheduling result to display the first interface and to not display the second interface.

Optionally, the processing module 702 is further used to: obtain a second request message of the first application, the second request message being used to request that the first interface not be displayed, and the second request message including the identifier of the first interface; remove the priority of the identifier of the first interface in the preset schedule strategy to obtain a first scheduling strategy, so that the first interface is not displayed and the second interface is displayed.

As for the description of the functional modules above, reference may be made to all relevant contents of corresponding steps involved in the embodiments of the method described above, and details will not be repeated here.

In some embodiments, FIG. 8 is a schematic structural diagram of a computing device. As shown in FIG. 8, the computing device 80 includes a processor 801 and a memory 802. The processor 801 is connected to the memory 802.

In some examples, the computing device 80 further includes a bus 803. The processor 801 and the memory 802 may be connected through the bus 803.

For example, the processor 801 is a control center of the computing device 80, which may be a processor, or may be a general term of a plurality of processing components. For example, the processor 801 may be a general-purpose central processing unit (CPU) or other general-purpose processor. The general processor may be a microprocessor or any conventional processor.

In an embodiment, the processor 801 may include one or more CPUs, such as the CPU 0 and the CPU 1 shown in FIG. 8.

The memory 802 may be a read-only memory (ROM) or a static storage device of any other type that may store static information and instructions, a random access memory (RAM) or a dynamic storage device of any other type that may store information and instructions, an electrically erasable programmable read-only memory (EEPROM), a magnetic disk storage medium or any other magnetic storage device, or any other medium that may be used to carry or store desired program codes in a form of instructions or data structures and that may be accessed by a computer, but is not limited thereto.

In a possible implementation manner, the memory 802 may be separate from the processor 801. The memory 802 may be connected to the processor 801 through a bus 803, and is used to store instructions or program codes. When the processor 801 calls and executes the instructions or program codes stored in the memory 802, the interface scheduling method provided in the embodiments of the present disclosure can be implemented.

In another possible implementation manner, the memory 802 may also be integrated with the processor 801.

The bus 803 may be an industry standard architecture (ISA) bus, a peripheral component interconnect (PCI) bus, or an extended industry standard architecture (EISA) bus, etc. The bus may be divided into an address bus, a data bus, a control bus, etc. For convenience of presentation, only one thick line is used to represent the bus in FIG. 8, but it does not mean that there is only one bus or one type of bus.

It should be pointed out that the structure shown in FIG. 8 does not constitute a limitation on the computing device 80. In addition to the components shown in FIG. 8, the computing device 80 may include more or less components, or combination(s) of certain components, or different components.

For example, with reference to FIG. 7, functions implemented by the obtaining module 701 and the processing module 702 in the interface scheduling device 70 are the same as functions implemented by the processor 801 in FIG. 8.

Optionally, as shown in FIG. 8, the computing device 80 provided in the embodiments of the present disclosure may further include a communication interface 804.

The communication interface 804 is used to connect other devices through a communication network. The communication network may be Ethernet, wireless access network, wireless local area network (WLAN), etc. The communication interface 804 may include a receiving unit for receiving data and a transmitting unit for transmitting data.

In a possible implementation manner, in the computing device 80 provided in the embodiments of the present disclosure, the communication interface 804 may also be integrated into the processor 801, which is not limited in the embodiments of the present disclosure.

As a possible product form, the interface scheduling device of the embodiments of the present disclosure can also be implemented using: one or more field programmable gate arrays (FPGAs), a programmable logic device (PLD), a controller, a state machine, a gate logic, a discrete hardware component, any other suitable circuit, or any combination of circuits capable of performing the various functions described in embodiments of the present disclosure.

From the above description of the embodiments, those skilled in the art may clearly understand that for convenience and brevity of description, only the above functional module/unit division is used as an example for illustration. In practical applications, the above functions may be assigned to different functional units to fulfill according to needs, that is, the internal structure of the device is divided into different functional units to achieve all or part of the functions described above. As for the detailed working processes of the systems, devices and units described above, reference may be made to the corresponding processes in the above method embodiments, which will not be repeated here.

The embodiments of the present disclosure further provide a non-transitory computer-readable storage medium having stored computer programs or instructions thereon. The computer programs or instructions, when run on a computer, cause the computer to implement the interface scheduling method as described in any of the above embodiments.

The embodiments of the present disclosure provide a computer program product including instructions that are carried on a non-transitory computer-readable storage medium. The instructions, when run on a computer, cause the computer to execute steps of the interface scheduling method as described in any of the above embodiments.

The embodiments of the present disclosure provide a chip system, and the chip system includes a processor and an interface circuit. The interface circuit is used to receive computer programs or instructions and transmit them to the processor. The processor is used to execute the computer programs or instructions, so that the chip system executes steps of the method processes shown in the above method embodiments.

Various computer-readable storage media described in the embodiments of the present disclosure may represent one or more devices and/or other machine-readable storage media for storing information. For example, the computer-readable storage medium may be, but is not limited to, an electrical, magnetic, optical, electromagnetic, infrared, or semiconductor system, device or apparatus, or any combination thereof. The computer-readable storage medium may include, but is not limited to: a portable computer disk, a hard driver, a RAM, a ROM, a smart card and a flash memory device (e.g., an erasable programmable read only memory (EPROM), a card, a stick or a key driver, etc.), a register, an optical fiber, a portable compact disk read-only memory (CD-ROM), an optical storage device, an optical disk (e.g., a compact disk (CD) or a digital versatile disk (DVD)), a magnetic storage device (e.g., a hard disk, a floppy disk or a tape), or any other form of computer-readable storage media. An exemplary computer-readable storage medium is coupled to the processor such that the processor can read information from the computer-readable storage medium and write information into the computer-readable storage medium. Of course, the computer-readable storage medium may also be a part of the processor. The processor and the computer-readable storage medium may be located in an ASIC. In the embodiments of the present disclosure, the computer-readable storage medium may be any tangible medium that contains or stores programs, and the programs may be used by or in conjunction with an instruction execution system, apparatus, or device.

Since the interface scheduling device, computing device, computer-readable storage medium, and computer program product provided by the embodiments can be applied to the above-mentioned interface scheduling method provided by the embodiments of the present disclosure, the obtained technical effects can also refer to the above embodiments of the interface scheduling method, which will not be repeated here.

Although the present application has been described herein in connection with various embodiments, in practicing the claimed application, those skilled in the art can understand and implement the disclosure by reviewing the drawings, the disclosure, and the appended claims. Other variations of the embodiment. In the claims, the term “comprises/comprising” does not exclude other components or steps, and “a” or “an” does not exclude more than one situation. A single processor or other module may perform several of the functions recited in the claims. The fact that certain measures are recited in mutually different dependent claims does not mean that a combination of these measures cannot be combined to advantageous effects.

Although the present disclosure has been described in conjunction with specific features and embodiments thereof, it will be apparent that various modifications and combinations may be made without departing from the spirit and scope of the present disclosure. Accordingly, the specification and drawings are merely intended to be illustrative of the present disclosure as defined by the appended claims and are to be construed to cover any and all modifications, variations, combinations or equivalents within the scope of the present disclosure. Obviously, those skilled in the art can make various changes and modifications to the present disclosure without departing from the spirit and scope of the present disclosure. In this way, if these modifications and variations of the present disclosure fall within the scope of the claims of the present disclosure and equivalent technologies, the present disclosure is also intended to include these modifications and variations.

What is claimed is:

1. An interface scheduling method, performed by a computing device, comprising:
obtaining a first request message of an application and an identifier of a second interface, wherein the first request message is used to request a display of a first interface of the application, the first request message includes an identifier of the first interface, and the second interface is a currently displayed interface;
determining a scheduling result according to a preset scheduling strategy, the identifier of the first interface and the identifier of the second interface, wherein the preset scheduling strategy includes priorities of a plurality of identifiers, and the plurality of identifiers include the identifier of the first interface and the identifier of the second interface; and
performing an interface scheduling on the first interface and the second interface according to the scheduling result.

2. The interface scheduling method according to claim 1, wherein determining the scheduling result according to the preset scheduling strategy, the identifier of the first interface and the identifier of the second interface includes:
determining a first priority of the identifier of the first interface in the preset scheduling strategy;
determining a second priority of the identifier of the second interface in the preset scheduling strategy; and
in a case where the first priority is lower than the second priority, determining that the scheduling result is to not display the first interface and to display the second interface.

3. The interface scheduling method according to claim 1, wherein determining the scheduling result according to the preset scheduling strategy, the identifier of the first interface and the identifier of the second interface includes:
determining a first priority of the identifier of the first interface in the preset scheduling strategy;
determining a second priority of the identifier of the second interface in the preset scheduling strategy; and
in a case where the first priority is higher than the second priority, determining that the scheduling result is to display the first interface and to not display the second interface.

4. The interface scheduling method according to claim 3, further comprising:
obtaining a second request message of the application, wherein the second request message is used to request that the first interface not be displayed, and the second request message includes the identifier of the first interface; and
removing the first priority of the identifier of the first interface in the preset scheduling strategy to obtain a first scheduling strategy such that the first interface is not displayed and the second interface is displayed.

5. An interface scheduling device, including:
an obtaining module used to obtain a first request message of an application and an identifier of a second interface, wherein the first request message is used to request a display of a first interface of the application, the first request message includes an identifier of the first interface, and the second interface is a currently displayed interface;
a processing module used to determine a scheduling result according to a preset scheduling strategy, the identifier of the first interface and the identifier of the second interface, wherein the preset scheduling strategy includes priorities of a plurality of identifiers, and the plurality of identifiers include the identifier of the first interface and the identifier of the second interface;
wherein the processing module is further used to perform an interface scheduling on the first interface and the second interface according to the scheduling result.

6. The interface scheduling device according to claim 5, wherein the processing module is used to determine the scheduling result according to a preset scheduling strategy, the identifier of the first interface and the identifier of the second interface includes the processing module is used to:
determine a first priority of the identifier of the first interface in the preset scheduling strategy;
determine a second priority of the identifier of the second interface in the preset scheduling strategy; and
in a case where the first priority is lower than the second priority, determine that the scheduling result is to not display the first interface and to display the second interface.

7. The interface scheduling device according to claim 5, wherein the processing module is used to determine the scheduling result according to a preset scheduling strategy, the identifier of the first interface and the identifier of the second interface includes the processing module is used to:
determine a first priority of the identifier of the first interface in the preset scheduling strategy;
determine a second priority of the identifier of the second interface in the preset scheduling strategy; and
in a case where the first priority is higher than the second priority, determine that the scheduling result is to display the first interface and to not display the second interface.

8. The interface scheduling device according to claim 7, wherein the processing module is further used to:
obtain a second request message of the application, wherein the second request message is used to request that the first interface not be displayed, and the second request message includes the identifier of the first interface; and
remove the first priority of the identifier of the first interface in the preset scheduling strategy to obtain a first scheduling strategy such that the first interface is not displayed and the second interface is displayed.

9. A computing device, comprising:
a memory used to store programs or instructions, and
a processor connected to the memory, wherein the programs or the instructions stored on the memory, when executed by the processor, cause the computing device to perform the interface scheduling method according to claim 1.

10. The computing device according to claim 9, wherein the programs or the instructions stored on the memory, when executed by the processor, cause the computing device to perform:
determining a first priority of the identifier of the first interface in the preset scheduling strategy;
determining a second priority of the identifier of the second interface in the preset scheduling strategy; and
in a case where the first priority is lower than the second priority, determining that the scheduling result is to not display the first interface and to display the second interface.

11. The computing device according to claim 9, wherein the programs or the instructions stored on the memory, when executed by the processor, cause the computing device to perform:
determining a first priority of the identifier of the first interface in the preset scheduling strategy;
determining a second priority of the identifier of the second interface in the preset scheduling strategy; and
in a case where the first priority is higher than the second priority, determining that the scheduling result is to display the first interface and to not display the second interface.

12. The computing device according to claim 11, wherein the programs or the instructions stored on the memory, when executed by the processor, cause the computing device to further perform:
obtaining a second request message of the application, wherein the second request message is used to request that the first interface not be displayed, and the second request message includes the identifier of the first interface; and
removing the first priority of the identifier of the first interface in the preset scheduling strategy to obtain a first scheduling strategy such that the first interface is not displayed and the second interface is displayed.

13. A non-transitory computer-readable storage medium has stored thereon computer programs or instructions, wherein the computer programs or the instructions, when run on a computer, cause the computer to perform:
obtaining a first request message of an application and an identifier of a second interface, wherein the first request message is used to request a display of a first interface of the application, the first request message includes an identifier of the first interface, and the second interface is a currently displayed interface;
determining a scheduling result according to a preset scheduling strategy, the identifier of the first interface and the identifier of the second interface, wherein the preset scheduling strategy includes priorities of a plurality of identifiers, and the plurality of identifiers include the identifier of the first interface and the identifier of the second interface; and
performing an interface scheduling on the first interface and the second interface according to the scheduling result.

14. The computer-readable storage medium according to claim 13, wherein the computer programs or the instructions, when run on a computer, cause the computer to perform:
determining a first priority of the identifier of the first interface in the preset scheduling strategy;
determining a second priority of the identifier of the second interface in the preset scheduling strategy; and
in a case where the first priority is lower than the second priority, determining that the scheduling result is to not display the first interface and to display the second interface.

15. The computer-readable storage medium according to claim 13, wherein the computer programs or the instructions, when run on a computer, cause the computer to perform:
determining a first priority of the identifier of the first interface in the preset scheduling strategy;
determining a second priority of the identifier of the second interface in the preset scheduling strategy; and
in a case where the first priority is higher than the second priority, determining that the scheduling result is to display the first interface and to not display the second interface.

16. The computer-readable storage medium according to claim 15, wherein the computer programs or the instructions, when run on a computer, cause the computer to further perform:
obtaining a second request message of the application, wherein the second request message is used to request that the first interface not be displayed, and the second request message includes the identifier of the first interface; and
removing the first priority of the identifier of the first interface in the preset scheduling strategy to obtain a first scheduling strategy such that the first interface is not displayed and the second interface is displayed.

17. A computer program product comprising instructions carried on a non-transitory computer-readable storage medium, wherein the instructions, when run on a computer, cause the computer to perform the interface scheduling method according to claim 1.

18. The computer program product according to claim 17, wherein the instructions, when run on a computer, cause the computer to perform:
determining a first priority of the identifier of the first interface in the preset scheduling strategy;
determining a second priority of the identifier of the second interface in the preset scheduling strategy; and
in a case where the first priority is lower than the second priority, determining that the scheduling result is to not display the first interface and to display the second interface.

19. The computer program product according to claim 17, wherein the instructions, when run on a computer, cause the computer to perform:
determining a first priority of the identifier of the first interface in the preset scheduling strategy;
determining a second priority of the identifier of the second interface in the preset scheduling strategy; and
in a case where the first priority is higher than the second priority, determining that the scheduling result is to display the first interface and to not display the second interface.

20. The computer program product according to claim 19, wherein the instructions, when run on a computer, cause the computer to further perform:
obtaining a second request message of the application, wherein the second request message is used to request that the first interface not be displayed, and the second request message includes the identifier of the first interface; and
removing the first priority of the identifier of the first interface in the preset scheduling strategy to obtain a first scheduling strategy such that the first interface is not displayed and the second interface is displayed.
